(19) United States
(12) Patent Application Publication
(10) Pub. No.: US 2025/0207686 A1
(43) Pub. Date: Jun. 26, 2025

(54) ELECTROMECHANICAL CONNECTION DEVICE AND DIRECTIONAL CONTROL VALVE EQUIPPED THEREWITH

(71) Applicant: Festo SE & Co. KG, Esslingen (DE)

(72) Inventors: Jakob BRENNER, Esslingen (DE); Peter RÜHLE, Weinstadt-Schnait (DE); Markus BRONNER, Esslingen (DE); Christoph SEIFRIED, Aichwald (DE)

(21) Appl. No.: 18/990,230

(22) Filed: Dec. 20, 2024

(30) Foreign Application Priority Data
Dec. 21, 2023 (DE) 10 2023 136 228.3

(51) Int. Cl. F16K 31/56; F16K 21/16; F16K 31/34

(52) U.S. Cl. CPC F16K 31/566; F16K 21/16; F16K 31/34

(57) ABSTRACT

An electromechanical connection device, which is designed for the releasable connection of a plurality of wire conductors serving to supply power to the directional control valve. It contains a plurality of connection structures, which respectively have a connection channel, which is delimited laterally in a clamping region by a moveable clamping element. A wire conductor inserted into the connection channel is electrically conductively clamped by the clamping element subjected to a spring force. All clamping elements are collectively associated with a release element, which can be driven to a release movement by introducing a manually generated release force, during which it acts on the clamping elements, such that each clamped wire conductor can be released for removal from the associated connection channel.

### CROSS-REFERENCE TO RELATED APPLICATION

This application claims the benefit of German application DE 10 2023 136 228.3 filed Dec. 21, 2023, which is incorporated herein by reference.

The invention relates to an electromechanical connection device for a directional control valve, designed for the releasable connection of a plurality of wire conductors serving to supply power to the directional control valve. The invention further relates to a directional control valve, having a valve member, an electrically actuated drive device for moving the valve member and an electromechanical connection device for the releasable connection of a plurality of wire conductors serving to supply power to the drive device.

An electromechanical connection device of this type described in EP 2 110 562 A1 as part of a directional control valve is designed as one of a plurality of connection units, which can be alternatively fixed to a valve assembly of the directional control valve in order to provide different connection options for wire conductors. The wire conductors serve to supply power to the directional control valve and in particular an electrically actuated drive device of the valve assembly, with the aid of which a valve member can be moved to switch between different switching positions. The connection unit has a plug interface to which a connector plug can be releasably connected, to which wire conductors combined in a cable are attached, which are connected to an electronic control device, for example. The electromechanical connection measures require a considerable amount of time and money, which is, inter alia, due to the pre-assembly of the wire conductors to be connected by fitting them with a connector plug.

EP 2 110 561 A1 discloses a directional control valve equipped with a connection unit, where an electrical connection cable is permanently fixed to the connection unit. Wire conductors formed by wires of the connection cable are permanently soldered to electrical conductors of an internal printed circuit board of the connection unit. In order to enable universal use, a relatively long cable length is required, which often means that the connection cable has to be cut to size during use and unnecessary cable pieces are discarded, which entails undesired material waste.

DE 10 2014 102 517 A1 discloses a connecting terminal for contacting electrical conductors, which has a plurality of clamping springs which can be respectively clamped to an electrical conductor to be connected and to each of which a separate actuating lever is assigned for its actuation.

### SUMMARY OF THE INVENTION

The object of the invention is to take measures that enable simple, cost-effective and material-saving contacting of directional control valves by means of wire conductors.

The object is achieved by means of an electrochemical connection device of the type mentioned in the introduction, which is characterized in that
it has a plurality of connection structures, which respectively have a connection channel provided to insert a conductor wire to be connected, which has a clamping region, which is delimited laterally by a clamping element, which can be moved between a basic position and an open position defining a larger cross-section of the clamping region compared to the basic position,
wherein an opening movement of the clamping element occurring in the direction of the open position is accompanied by the build-up of a spring force provided by a spring structure and acting on the clamping element in a restoring manner in the direction of the basic position such that a wire conductor inserted into the associated clamping region can be electrically conductively clamped by the clamping element deflected from the basic position into a clamping position located between the basic position and the open position,
wherein the independently moveable clamping elements of all connection structures are collectively associated with a release element of the connection device, which, starting from an inactive position enabling each clamping element to assume its basic position, can be driven to a release movement acting on all clamping elements by introducing a manually generated release force, during which it causes an opening movement of all clamping elements, such that each clamped wire conductor can be released for removal from the associated connection channel.

The object is further achieved by means of a directional control valve of the type mentioned in the introduction, the electromechanical connection device of which is designed as described above.

In this way, an electromechanical connection device is provided, which easily enables wire conductors provided for power supply to be connected to a directional control valve such that they are both mechanically fixed and electrically contacted in relation to the directional control valve. The power supply is used to actuate the directional control valve for setting different switching states. The wire conductors are, for example, connected to an electronic control device for providing the power supply, wherein the power supply is manifested in particular in the transmission of electrical actuating signals. The connection device contains at least two connection structures, which are respectively suitable for the releasable connection of one of a plurality of electrically conductive wire conductors, which are, for example, single-wire conductors or stranded conductors consisting of a plurality of thin wire strands. Each connection structure contains its own connection channel which has a clamping region delimited laterally by a moveable clamping element and into which the wire conductor to be connected can be inserted such that it passes through the clamping region with one longitudinal section. A spring structure is associated with each clamping element and ensures that the wire conductor inserted into the clamping region is releasably clamped by the clamping element while simultaneously providing an electrically conductive connection. The wire conductor to be connected can in particular be inserted during a basic position of the associated clamping element, which means that the clamping element is deflected from the basic position into a clamping position with the built-up of a restoring spring force and ultimately holds the wire conductor by this spring force. A plurality of wire conductors can be fixed in different connection channels and electrically contacted in this way independently of one another, for example simultaneously or consecutively. As the wire conductors are not already permanently attached to the connection device ex-works, they can, if needed, be made available in the respectively desired length at very low cost by the user by appropriately cutting them to size from a wire conductor reel, which prevents the occurrence of non-recyclable wire waste. For the connection process itself, no handling of the connection device is expediently required, as the clamping elements are preferably deflected from the basic position by the wire conductors themselves when the wire conductors are inserted. A particular advantage is the option to simultaneously release all connected wire conductors as required, making them ready for removal, which is ensured by a release element collectively assigned to all connection structures. The release element normally assumes an inactive position, in which it enables the basic position of all clamping elements and also allows them to be deflected into a clamping position such it does not impair the connection process for the wire conductors. If the wire conductors are to be removed from the connection device, a manually generated release force can be applied to the release element directly or indirectly, in particular using a finger of a hand, which results in a release movement of the release element during which it acts on all clamping elements. The same are thereby driven to an opening movement in the direction of an open position such that the cross-section of each clamping region is increased and the previously clamped wire conductors are released such that they can be removed from the associated connection channel in particular by being pulled out. When the release force is subsequently removed from the release element, the clamping elements can return to their basic position, in which each clamping region has a minimal cross-section, which can also be equal to zero. The assignment of a collective release element to all available clamping elements simplifies the release process of the wire conductors and provides the option for a compact and space-saving construction of the connection device. If needed, the release element can also be used when the wire conductors are connected in order to deflect the clamping elements and enable resistance-free, easy insertion of the wire conductors into the connection channels.

A directional control valve according to the invention contains an electromechanical connection device with the aforementioned features, wherein the connection device can be integrated into the directional control valve as a fixed component or be designed as a releasable valve component. The latter enables the directional control valve to be designed in such a way that other types of connection devices can be fitted instead of the connection device according to the invention if required, in particular those that have a plug interface suitable for a connector plug.

Advantageous embodiments of the invention are cited in the sub-claims.

It is advantageous if the connection device is designed as a connection unit that can be handled as a single entity and has an electromechanical interface via which it can be attached to a valve assembly of the directional control valve, wherein the electromechanical interface preferably allows a releasable attachment to the valve assembly. Alternatively, the connection device can also be integrated into a directional control valve without clear demarcation from other components.

The clamping elements expediently have inherently resiliently bendable properties such that they respectively themselves directly form the spring structure associated with them suitable for building up the spring force. The clamping elements are preferably designed like a leaf spring, wherein they are in particular formed by suitably bent leaf springs. Such a design is simpler and more cost-effective than an embodiment, which is also possible in principle, in which the movable clamping elements are acted upon by spring structures designed as separate springs.

In particular in connection with the inherently resilient properties, it is advantageous if the clamping elements are designed to be tongue-like with a free end section such that the clamping elements can be pivoted during the opening movement and can respectively be moved between the basic position and the open position as part of a pivot movement.

The release element is expediently designed such that it is spaced apart from every clamping element in the inactive position irrespective of the position of the clamping elements. This ensures that the clamping elements can assume their basic position irrespective of manufacturing tolerances in the inactive position of the release element.

The clamping elements can in principle be designed such that they are stress-neutral in the basic position and a spring force acting in a restoring manner in the direction of the basic position only arises when they are deflected from the basic position. However, a design is preferable in which each clamping element is pre-tensioned into the basic position by the associated spring structure. This can reliably guarantee that even very thin wire conductors are securely held. Each clamping element in the basic position expediently lies under pre-tension on an opposite support wall section of a channel wall delimiting the associated connection channel.

Each connection structure expediently has a clamping unit made of metal and fixed to a device housing of the connection device either directly or indirectly. The respectively associated connection channel extends in the clamping unit, wherein the connection channel can be limited to the clamping unit or continue outside of the clamping unit in the device housing. In any case, the connection channel extends into the clamping unit at least with a longitudinal section containing the clamping region. The clamping element is an integral component of the clamping unit, wherein it can be integrated into the clamping unit integrally or as a separate component.

It is favourable if each clamping unit has a base body, which forms an electrically conductive channel wall of the associated connection channel. In this case, the associated clamping element expediently has a force absorption tab protruding outward beyond the channel wall, on which the release element can act to cause an opening movement of the clamping element. The channel wall is expediently passed through by the release element.

Each connection channel preferably has an inner longitudinal section extending in the clamping unit and containing the clamping region and an outer longitudinal section adjacent thereto and formed in the device housing. The outer longitudinal section of the connection channel ends outside on the device housing with a wire insertion opening enabling the insertion of the wire conductor to be connected. In this way, the clamping units can be shielded from the environment in the device housing, which prevents the clamping units from being unintentionally touched and any short-circuits from occurring.

If the connection channels extend exclusively in the clamping units, the wire insertion openings are also located on the clamping units.

The connection device preferably contains a printed circuit board surrounded by a device housing of the connection device and fixed in relation to the device housing, on which the clamping units of the plurality of connection structures are mounted, for example by soldering. In this way, the clamping units are indirectly fixed to the device housing with the printed circuit board in between. The clamping units are electrically conductively connected via a conductor track structure containing a plurality of conductor tracks to contact elements of the connection device, at which an actuating voltage for the directional control valve, which produces the power supply, can be tapped. Said contact elements are expediently components of the aforementioned electromechanical interface of a connection device preferably designed as a connection unit.

The release element is expediently designed to be tongue-like and has a free end section, wherein the release movement is a pivot movement, during which the release element is pivoted at least in the region of the free end section. The release element is advantageously an integrally integrated housing component of a device housing of the connection device, which is in particular made of plastic. In this way, the release element can be structured cost-effectively directly during the manufacture of the device housing, which is carried out in particular by injection moulding.

It is advantageous if the release element has inherently resiliently bendable properties such that it automatically returns to the inactive position after an induced release force has been removed and after a resulting deflection. The inactive position of the release element is expediently a force-neutral position of the release element such that a restoring force acing in the direction of the inactive position only materializes when a release movement is executed.

In one advantageous arrangement, the connection channels are placed next to one another such that they are aligned parallel to one another, with a channel longitudinal direction extending in a height direction of the connection device. Each connection channel ends at a first outer surface of the connection device with a wire insertion opening enabling the insertion of a wire conductor to be connected. The release element or at least an activation section of the release element that can be used for introducing the release force is located in the region of a second outer surface of the connection device oriented orthogonally to the first outer surface. The entire release element is preferably arranged in the region of the second outer surface of the connection device, wherein it expediently helps form the second outer surface.

On the release element, there is expediently a number of force induction protrusions corresponding to the number of clamping elements, which protrusions protrude in the direction of the clamping elements and which respectively act in a pressing manner on one of the existing clamping elements during the release movement of the release element in order to produce its opening movement. The force induction protrusions are in particular designed like tabs and preferably protrude into a device housing of the connection device in which the clamping elements are located.

The release element is expediently designed to directly induce the release force. For example, the release element can, for example, be actuated directly with a finger of a hand or by means of an actuating tool used as an extension and held in the hand, such as a screwdriver. Such actuation can, for example, take place directly on the second outer surface.

Under certain circumstances, a directional control valve equipped with the connection device is installed at the site in the ready-to-use state such that the second outer surface having the release element or at least an activation section of the release element is covered and not directly accessible or only having limited accessibility. In particular for such cases, it is advantageous if the connection device has a tool insertion opening, which, on the one hand, opens out in the vicinity of the wire insertion openings on the first outer surface and, on the other, is open towards the release element in the region of the second outer surface. It is thus possible to insert an actuating tool, for example the shaft of a screwdriver, from the side of the first outer surface through the tool insertion opening in order to act on the release element. The boundary wall of the tool insertion opening can be used to guide the actuating tool and/or to support it when the actuating tool is pivoted to apply a leverage effect to the release element.

In principle, the connection device can be equipped with an actuating element available in addition to the release element, which interacts in a force-transmitting manner with the release element and which can be adjusted by a manually produced actuating force in order to act on the release element to generate the release force. The force direction of the actuating force expediently deviates from the force direction of the release force to be produced and is in particular oriented perpendicular thereto. By designing the contact region between the actuating element and the release element accordingly, a force transmission can be realized if required. It is particularly advantageous if the actuating element is designed as a linear-moving actuating slide, which is preferably displaceably mounted on a device housing of the connection device.

A directional control valve which is or can be equipped with the connection device can be equipped with an electrically actuated drive device for actuating the valve member, allowing direct actuation or indirect, pilot-controlled actuation. For direct actuation, the drive device can, for example, contain an electromagnetic actuator acting mechanically on the valve member. For pilot-controlled actuation, the drive device is designed as a pilot control valve device, the electrical actuation of which, via the connection device, can be used to control the application of a drive fluid to the valve member in order to move the valve member into different switching directions by controlled fluid application. The pilot control valve device contains, for example, one or two pilot control valves in the form of solenoid valves or piezo valves.

The electromechanical connection device is preferably arranged directly on the electrically actuated drive device such that there are short current paths and compact dimensions are possible.

The valve member and the electrically actuated drive device of the directional control valve are expediently combined in a valve assembly of the directional control valve, on which there is an electromechanical mating interface to an electromechanical interface formed on the connection device. The connection device preferably designed in this case as a connection unit that can be handled as a single entity can be or is attached to the valve assembly by interaction of the interface and mating interface in such a way that there is an electrically conductive connection between the connection structures of the connection device and the electrically actuated drive device.

The directional control valve can expediently be defined such that it has a longitudinal axis extending in a longitudinal direction and a vertical axis orthogonal thereto and extending in a height direction. The valve member is preferably oriented in such a way that it can be adjusted in the longitudinal direction to change the switching position. The connection device designed in particular as a connection unit is located in an axial end region of the directional control valve oriented in the longitudinal direction, wherein the connection channels are oriented such that they open out at a first outer surface of the connection device oriented in the height direction in order to insert the wire conductors. The release element or at least an activation section of the release element that can be used for introducing the release force is located in the region of a second outer surface of the connection device oriented in the longitudinal direction of the directional control valve.

The connection device expediently has exactly two connection structures, which are collectively assigned a single release element. In conjunction with this type of equipment, the directional control valve is expediently a monostable design with spring return of the valve member. Out of the two connection structures, one can be used for earth and the other as the positive pole of an actuating voltage. If the drive device is designed accordingly, a connection device provided with only two connection structures can also be used to supply power to a bistable directional control valve. Alternatively, in order to supply power to a bistable directional control valve, there is also the option of equipping the connection device with three connection structures, which are collectively assigned a single release element. In this case, one of the connection structures can be used for earth and the two other connection structures as the positive pole of two actuating voltages.

### BRIEF DESCRIPTION OF DRAWINGS

The invention is explained below in more detail based on the appended drawing. In the figures:

FIG. 1 is an isometric illustration of a preferred embodiment of the directional control valve according to the invention, which is equipped here with a preferred design of an electromechanical connection device, wherein a wire conductor is shown in the connected state and another wire conductor is shown during a connection process, wherein a region of the connection device framed by a dotted line is also illustrated separately in an alternative design,

FIG. 2 is an individual illustration of the electromechanical connection device in a side view with viewing direction according to arrow II from FIG. 1,

FIG. 3 is a rear view of the connection device with viewing direction according to arrow III from FIGS. 2 and 7,

FIG. 4 shows a longitudinal section of the connection device according to section line IV-IV from FIG. 3 in the connected state of a wire conductor, wherein the release element adopts its inactive position and the associated clamping element adopts a clamping position and wherein the basic position of the clamping element is shown by dotted lines, wherein an axial end region of a valve assembly of the directional control valve is also shown, on which the connection device can be mounted and is mounted in accordance with FIG. 1,

FIG. 5 shows a cross-section of the connection device according to section line V-V from FIGS. 3 and 4,

FIG. 6 is an isometric individual illustration of the connection device shown in FIGS. 1 to 5, wherein the release element adopts an active position enabling a connected wire conductor to be removed and caused by imposing a release force,

FIG. 7 is a side view of the connection device with viewing direction according to arrow VII from FIG. 6,

FIG. 8 shows a longitudinal section of the connection device according to section line VIII-VIII from FIGS. 3 and 10 in the active position of the release element shown in FIGS. 6 and 7, wherein a clamping element is shown, which is moved by the active release element into an open position that releases the inserted wire conductor for removal,

FIG. 9 shows a longitudinal section of the connection device according to section line IX-IX from FIG. 3, again in an active position of the release element, wherein the use of an actuating tool, indicated by a dashed line and inserted into a tool insertion opening, to induce a release force is indicated,

FIG. 10 shows a cross-section of the connection device according to section line X-X from FIGS. 3 and 8 in the operating state shown in FIGS. 6 and 8, and

FIG. 11 is an isometric individual illustration of one of the clamping units contained in the connection device and equipped with a clamping element.

### DETAILED DESCRIPTION OF INVENTION

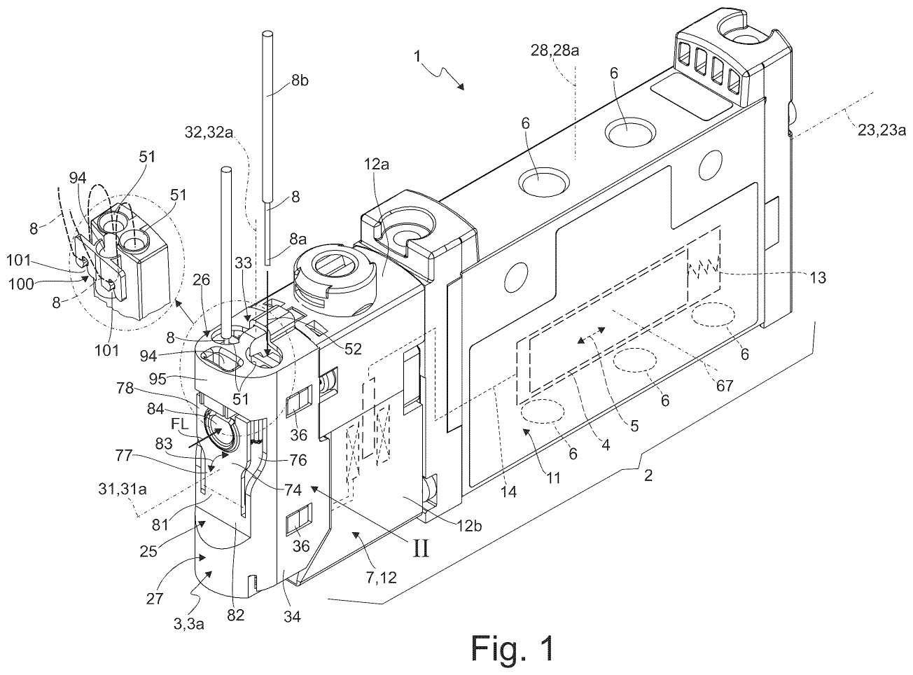

FIG. 1 shows an electrically actuated directional control valve 1, which is designed to control fluid flows and can in particular be used to apply a fluidic pressure medium, in particular compressed air, in a controlled manner to a connected fluid-actuated drive not further illustrated in the drawing for the purpose of its actuation. The controlled pressurization can occur by either supplying or removing a fluidic pressure medium to or from the fluid-actuated drive.

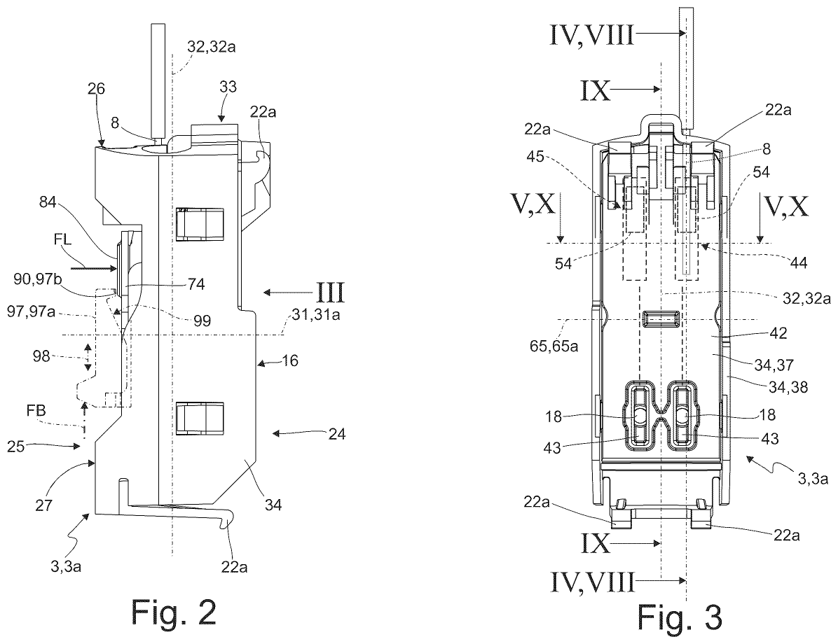

The directional control valve 1 contains a valve assembly 2 and an electromechanical connection device 3 arranged on the valve assembly 2 in its use position. The connection device 3 is also shown separately in various views and sections in FIGS. 2 to 10.

The directional control valve 1 contains a valve member 4 shown only schematically by dashed lines and designed, for example, as a valve slide, which can be driven to a switching movement 5 indicated by a double arrow in order to position it in various switching positions. Depending on the adopted switching position, valve channels 6 opening out on the outside of the directional control valve enable a fluidic pressure medium to flow out or flow back to or from a fluid-actuated drive. By way of example, there are five valve channels 6, including two for connection to the fluid-actuated drive, one for connection to an external pressure source provided the pressure medium to be controlled and enabling ventilation of the fluid-actuated drive and two for connection to a pressure sink, in particular to the atmosphere for enabling ventilation of the fluid-actuated drive.

The switching movement 5 and the resulting specification of different switching positions of the valve member 4 is caused by an electrically actuated drive device 7 of the valve assembly 2. The electromechanical connection device 3 referred to below only as a connection device 3 for reasons of simplicity enables the electrical power supply required to actuate the drive device 7 and enables the releasable connection of a plurality of electrically conductive wire conductors 8, which are or can be connected to an electronic control device or another voltage source.

By way of example, the wire conductors 8 are designed as individual wires that can be handled individually, but they can also readily be realized as wires of a multi-core power cable.

In one preferred design, the directional control valve 1 has an electrofluidic and in particular electro-pneumatic pilot-controlled design in accordance with the illustrated exemplary embodiment. For this purpose, the valve assembly 2 contains a main valve 11, equipped with the valve member 4 and the valve channels 6, and an electrically actuated pilot control valve device 12 formed by the drive device 7. The pilot control valve device 12 contains one or two electrically actuated pilot control valves, which are in particular solenoid valves. The exemplary directional control valve 1 has a monostable functionality, in which the valve member 4 is pre-tensioned by a spring device 13 into a first switching position, from which it can be moved into a second switching position by application of a drive fluid as part of the switching movement 5. The application of the drive fluid can be controlled by the pilot control valve device 12 containing by way of example just one single pilot control valve. A pilot control channel 14 provided for fluid application is shown by dotted lines in FIG. 1. It communicates with a valve unit 12a of the pilot control valve device 12, which can be actuated by an electrically actuated drive unit 12b of the pilot control valve device 12 equipped in particular with an electromagnet in order to selectively ventilate or bleed the pilot control channel 14. The drive fluid for the pilot control can be supplied separately to the pilot control valve device 12 or is branched off from the main valve 11.

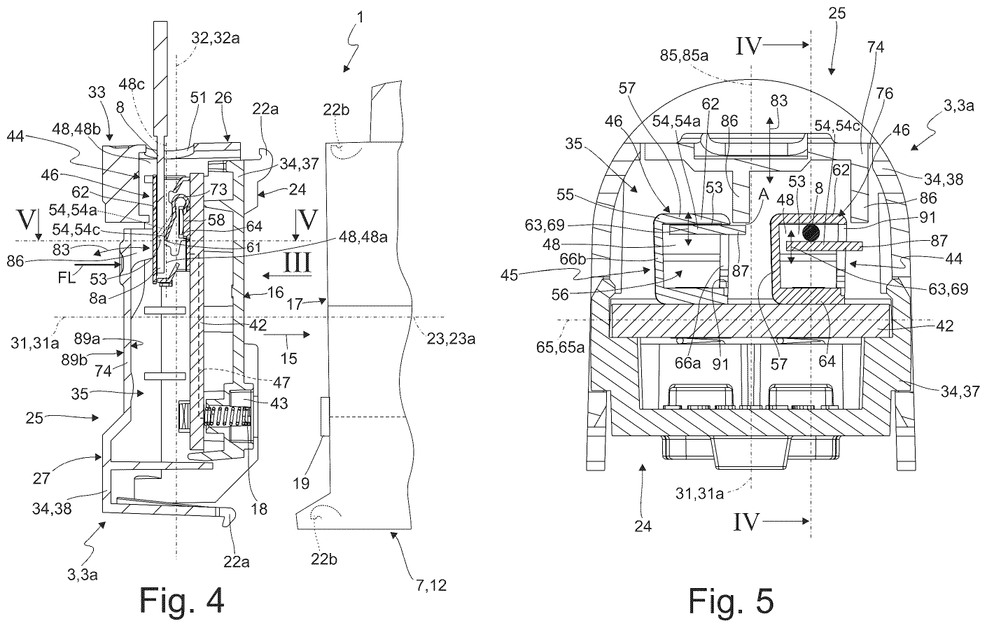

The connection device 3 is preferably arranged directly on the drive device 7. It is designed in particular as a connection unit 3a that can be handled as a single entity independently of the valve assembly 2 and which is releasably attached to the valve assembly 2 in its use position. In FIG. 4, an assembly arrow 15 illustrates how the connection unit 3a can be attached to a complementary electromechanical mating interface 17 of the valve assembly 2 to complete the directional control valve 1 with an electromechanical interface 16. By way of example, the mating interface 17 is located on the drive device 7.

In the mounted use position of the connection unit 3a, the wire conductors 8 connected to the connection unit 3a are electrically conductively connected to the drive device 7 and, by way of example, to the drive unit 12b. The electrical connection is established in the joining region between the connection unit 3a and the valve assembly 2 by interaction between contact elements 18 formed at the interface 16 and mating contact elements 19 formed at the mating interface 17. When the connection unit 3a is mounted, these are electrically conductively plugged into one another or pressed against one another.

The mechanical connection between the connection unit 3a and the valve assembly 2 is established, by way of example, by interaction between a first holding structure 22a arranged at the interface 16 and a second holding structure 22b arranged at the mating interface 17. The two holding structures 22a, 22b can cooperate with one another in particular in a latching manner. Alternatively, other measures for a releasable mechanical connection are also possible, such as a screw connection.

The directional control valve 1 extends in the axial direction of a longitudinal axis 23, referred to as the longitudinal direction 23a. The directional control valve 1 also has a vertical axis 28 orthogonal in relation to its longitudinal axis 23 and extending in a height direction 28a. Furthermore, it has a transverse axis 67, which is oriented orthogonally to the longitudinal axis 23 and the vertical axis 28.

The valve assembly 2 and the connection unit 3a are expediently strung together in the longitudinal direction 23a, wherein, by way of example, the drive device 7 is placed between the main valve 11 and the connection unit 3a. For the accessibility of the connection unit 3a, it is advantageous if it is located in an axial end region of the directional control valve 1 oriented in the longitudinal direction 23a in accordance with the illustrated exemplary embodiment. This applies mutatis mutandis to an embodiment of the connection device 3 which is designed as an inseparable integral part of the directional control valve 1.

Unless otherwise specified, references to the connection device 3 apply mutatis mutandis to the connection unit 3a and vice versa.

The connection device 3 has a rear side 24 facing the valve assembly 2 on which the electromechanical interface 16 is located. The connection device 3 also has a front side 25 opposite and facing away from the rear side 24 and, for example, pointing away from the valve assembly 2 in the longitudinal direction 23a. An outer surface of the connection device 3 associated with this front side 25 is referred to as the second outer surface 27. It forms, by way of example, an axial end face of the directional control valve 1.

The connection device 3 or the connection unit 3a has a longitudinal axis 31 extending in a longitudinal direction 31a and a vertical axis 32 perpendicular thereto and extending in a height direction 32a. The connection device 3 has another outer surface on an upper side 33 oriented perpendicular to the front side 25 or the second outer surface 27, which is referred to as the first outer surface 26 for better differentiation. Within the directional control valve 1, the connection device 3 is oriented such that its longitudinal axis 31 runs parallel to the longitudinal axis of the directional control valve 1 and its vertical axis 32 is oriented parallel to the vertical axis 28 of the directional control valve 1.

Regardless of the above axis designations, the directional control valve 1 can be operated with any spatial orientation.

The connection device 3 in the exemplary embodiment has a device housing 34, which surrounds a housing interior 35. The device housing 34 preferably made of plastic contains, for example, a housing base 37 and a hood-shaped housing cover 38 placed onto the housing base 37. The housing base 37 and housing cover 38 are, for example, fixed to one another by snap-in engagement means 36. The housing base 37 is located, for example, on the rear side 24 of the connection unit 3a. The first and second outer surfaces 26, 27 are located on the housing cover 38.

In the housing interior 35, a printed circuit board 42 is fixed to the device housing 34, which is oriented in particular in such a way that its board plane extends orthogonally to the longitudinal axis 31. The aforementioned contact elements 18 are located on the printed circuit board 42 and can respectively be accessed from the rear side 24 through a base opening 43 of the housing base 37 in order to be able to make electrical contact with the associated mating contact elements 19. The contact elements 18 are fitted with contact springs, for example.

The connection device 3 is equipped with a plurality of connection structures 44, 45, which respectively enable a releasable electromechanical connection of one of the aforementioned wire conductors 8. By way of example, there are exactly two connection structures 44, 45, which are also referred to as the first and second connection structures 44, 45 for better differentiation. However, there can also be more than two and in particular three connection structures.

Each connection structure 44, 45 expediently contains its own clamping unit 46. The plurality of clamping units 46 are expediently identical in design. The clamping units 46 are preferably located fully in the housing interior 35 of the device housing 34. Each clamping unit 46 is fixed to the device housing 34, wherein, however, there is no direct fixing, for example, but rather an indirect fixing resulting from the clamping units 46 being attached to the printed circuit board 42 itself fixed to the device housing 34.

By way of example, the clamping units 46 are attached to a first board surface 42a of the printed circuit board 42, which is facing the front side of the connection device 3. The contact elements 18 are expediently located on a second board surface 42b of the printed circuit board 42 opposite the first board surface 42a.

In a manner known per se, the printed circuit board 42 is equipped with a conductor track structure 47, indicated only by a dashed line, which independently of one another establishes an electrically conductive connection between respectively one of the two clamping units 46 and one of the contact elements 18 present in the same number as the clamping units 46, i.e. also present as two in this example.

The clamping units 46 expediently consist entirely of a metal and thus of an electrically conductive material, and they are in contact with the conductor track structure by solder connections, for example. The latter also expediently applies to the contact elements 18.

Each connection structure 44, 45 has a connection channel 48, into which a wire conductor 8 to be connected can be inserted with a connection end 8a. In order to prevent short circuits, each wire conductor 8 is expediently surrounded by a plastic insulating sheath 8b, apart from its connection end 18a. Each wire conductor 8 can have its own insulating sheath 8b, and it is also possible for all wire conductors 8 to be surrounded by one and the same insulating sheath to form a multi-core cable.

Each connection channel 48 has, for example, an inner longitudinal section 48a extending in the associated clamping unit 46 and an outer longitudinal section 48b adjacent thereto and formed in the device housing 34. The outer longitudinal section 48b ends outside on the device housing 34 with a wire insertion opening 51, through which the wire conductor 8 to be connected can be inserted into the connection channel 48.

The outer longitudinal sections 48b of the connection channels 48 result from the fact that the clamping units 46 are accommodated in the housing interior 35 at a distance from each outer surface of the device housing 34. A distance between each clamping unit 46 and the outside of the device housing 34 is bridged by the outer longitudinal sections 48b. In this way, each wire insertion opening 51 is spaced apart from the associated clamping unit 46.

However, an embodiment is also possible in which the clamping units 46 are installed flush with an outer surface of the device housing 34 such that each connection channel 48 only extends in the associated clamping unit 46 and the wire insertion openings 51 are formed by openings in the clamping units 46.

The connection structures 44, 45 are preferably oriented such that the connection channels 48 extend next to one another oriented parallel to one another such that the wire insertion openings 51 also have an identical orientation to one another. The wire insertion openings 51 are preferably arranged next to one other with only a small distance between them.

By way of example, the connection channels 48 extend in the height direction 32a of the connection device 3, wherein the wire insertion openings 51 are placed on the first outer surface 26 of the connection device 3 formed outside on the device housing 34. The insertion of a wire conductor 8 to be connected into a connection channel 48, indicated by an arrow 52 in FIG. 1, can thus take place in the height direction 32a.

There is a clamping region 53 in the course of each connection channel 48. The clamping region 53 is formed by a longitudinal section of the connection channel 48 having a variable cross-section, which is expediently relatively short. By way of example, each clamping region 53 is located inside one of the clamping units 46.

Each clamping region 53 is delimited by a moveable clamping element 54, wherein the movement of the clamping element 54 enables a change in cross-section of the clamping region 53.

Each clamping element 54 is preferably an integral part of the associated clamping unit 46. This results in simple mounting on the printed circuit board 42. Each clamping element 54 and expediently each entire clamping unit 46 consists of a metal, resulting in electrical conductivity, wherein a copper alloy is preferably used.

Each clamping unit 46 preferably has an in particular integrally formed base body 55, which has a hollow profile according to FIGS. 5, 10 and 11 and in particular has the basic structure of a hollow profile body with a rectangular cross-section. The base body 55 surrounds a base body interior 56, which, for example, defines the inner longitudinal section 48a of the connection channel 48. The base body 56 thus forms an electrically conductive channel wall 57 of the associated connection channel 48.

Each clamping element 54 is attached to the associated base body 55 with a fixed end section 58. The attachment can result from an integral connection if the base body 55 and clamping element 54 have an overall integral structure. Alternatively, a clamping element 54 separate from the base body 55 can be electrically conductively fixed to the base body 55 by suitable attachment measures with its fixed end section 58, for example by crimping or by means of a cohesive connection such as welding.

Starting from the fixed end section 58, each clamping element 54 protrudes into the associated base body interior 56, wherein it ends with a free end section 61. This is due to the fact that each clamping element 54 has a tongue-like design. Each clamping region 53 is delimited by the free end section 61 of the clamping element 54 and a wall section of the channel wall 57 opposite the free end section 61, which will be referred to as the support wall section 62 below for better differentiation and which is a section of the base body 55, for example.

The tongue-like design of the clamping element 54 results in the aforementioned movement of the clamping element 54, which primarily manifests itself in a movement of the free end section 61. To simplify the description, the potential movement of the respective clamping element 54 is referred to in general as the working movement 63. Caused by the tongue-like shape of the clamping element 54, the working movement 63 is, for example, a pivot movement 69 with the region of the fixed end section 58 as the pivot centre.

During the working movement 63, the distance between the clamping element 54 and the support wall section 62 changes, getting bigger or smaller depending on the movement direction, which also applies accordingly to the cross-section of the clamping region 53.

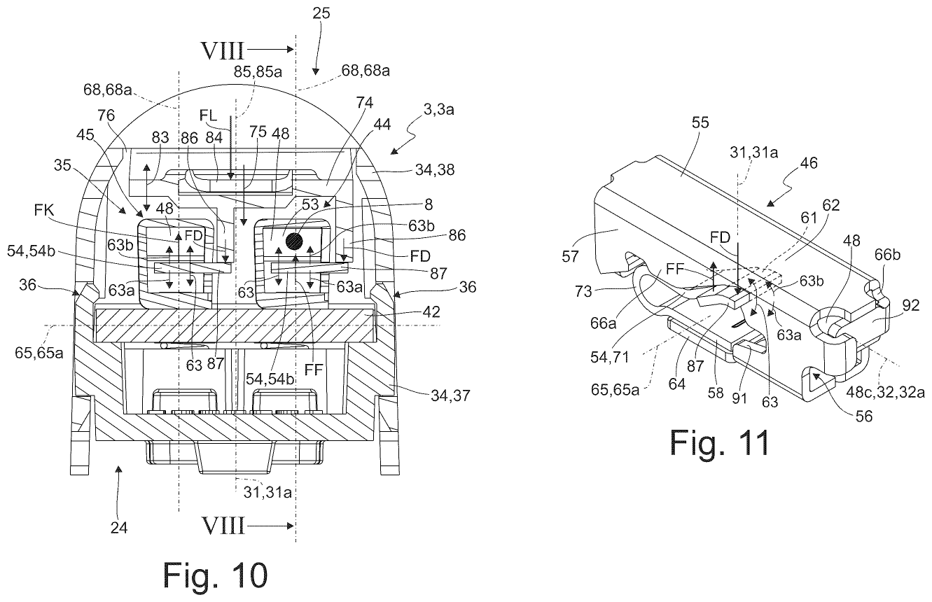

As part of the working movement 63, the clamping element 54 can be moved between a basic position 54a shown in FIG. 5 for the clamping element 54 of the second connection structure 45 and an open position 54b present in FIG. 10 for all clamping elements 54. In the open position 54b, the clamping region 53 has a maximum cross-section, caused by a maximum distance between the free end section 51 and the support wall section 62. In the basic position 54a, the clamping region 53 has a minimum cross-section, which is defined by a minimum distance between the free end section 51 an the support wall section 62, wherein the minimum cross-section is equal to zero in the illustrated exemplary embodiment as the clamping element 54 rests against the opposite support wall section 62 in the basic position 54a.

The base body 55 of each clamping unit 46 has a base section 64, with which it is attached to the first board surface 42a of the printed circuit board 42. The support wall section 62 is located opposite the base section 64 at a distance in the longitudinal direction 31. Two side wall sections 66a, 66b of the base body 55 spaced apart from one another in a transverse direction 65a of the connection device 3 extend between the support wall section 62 and the base section 64, wherein the transverse direction 65a is the axial direction of a transverse axis 65, which runs orthogonally to the longitudinal axis 31 and to the vertical axis 32 of the connection device 3. The transverse axis 65 of the connection device 3 extends parallel to the transverse axis 67 of the directional control valve 1. The base body interior 56 is delimited by the support wall section 62, the base section 64 and the two side wall sections 66a, 66b, which together form the aforementioned electrically conductive channel wall 57 of the connection channel 48.

The working movement 63 of each clamping element 54 can, for example, be respectively carried out in a movement plane 68 which runs orthogonally to the transverse axis 65. Owing to the pivotability of the clamping elements 54, the movement plane 68 is, for example, a pivot plane 68a. During the working movement 63, the distance between each clamping element 54 and the front side 25 of the connection device 3 also changes, inter alia.

The working movement 63 can take place in two opposing directions, wherein for better differentiation a working movement 63 that takes place in the direction of the open position 54b is referred to as an opening movement 63a and an opposite working movement 63 that takes place in the direction of the basic position 54a is referred to as a closing movement 63b.

Each clamping element 54 is assigned a spring structure 71 having resilient properties which has the effect the that opening movement 63a of the clamping element 54 is accompanied by the build-up of a spring force FF acting on the clamping element 54 in question in the direction of the basic position 54a. This spring force FF increases the further the clamping element 54 moves away from the basic position 54a.

Each clamping element 54 preferably rests against the associated support wall section 62 in the basic position 54a. The spring structures 71 are in particular designed such that the clamping elements 54 are already subjected to a spring force FF in the basic position 54a such that they are pre-tensioned by the respectively associated spring structure 71 into the basic position 54a and against the support wall section 62.

Each connection channel 48 has a channel end 72 opposite the wire insertion opening 51. It is located, for example, in the base body interior 56, wherein the clamping region 53 lies between the wire insertion opening 51 and the channel end 72. The clamping element 54 is oriented such that its free end section 61 points in the direction of the channel end 72. Overall, the clamping element 54 is preferably shaped such that the free end section 61 in the basic position 54a is orientated obliquely with respect to a longitudinal channel axis 48c of the associated connection channel 48. The clamping element 54 is preferably structured such that, starting from the fixed end section 58, it initially extends in the direction of the wire insertion opening 51 and then transitions with a U-shaped curved section 73 into an oppositely directed longitudinal section, which ends with the obliquely extending free end section 61. The exemplary clamping element 54 is therefore designed to be substantially U-shaped, with the two end sections 58, 61 as the U-legs.

A wire conductor 8 to be connected is inserted through the selected wire insertion opening 51 into the adjoining connection channel 48 with its connection end 8a in front in accordance with the insertion arrow 52 (FIG. 1), wherein, when it reaches the clamping region 53, it strikes the free end section 61, which is in the basic position 54a, and deflects it out of the basic position 54a against the spring force FF as the insertion movement continues. The clamping element 54 thereby performs an opening movement 63a. Once the wire conductor 8 passes through the clamping region 53 which has an increased cross-section due to the deflected clamping element 54, it is pressed against the support wall section 62 by the clamping element 54 under the clamping force FF and is subsequently clamped in an electrically conductive manner between the clamping element 54 and the support wall section 62. In this way, the inserted wire conductor 8 is mechanically held in place, preventing it from being pulled out, and also makes electrically conductive contact with the clamping unit 46.

If, for whatever reason, a tensile force is subsequently exerted on the wire conductor 8, the free end section 61 of the clamping element 54, which is preferably sharp-edged, bites into the wire conductor 8 and thus creates a form-locking holding force in addition to the clamping force that resists removal.

The position adopted by the clamping element 54 in the state deflected by the wire conductor 8 is referred to as clamping position 54c for better differentiation. The clamping position 54c lies between the basic position 54a and the open position 54c and can be seen in the drawing in particular in FIG. 4 and also in FIG. 5 in the first connection structure 44 shown on the right-hand side.

In accordance with the illustrated exemplary embodiment, it is advantageous if the clamping elements 54 respectively themselves directly form the spring structure 71 associated with them by having inherently resiliently bendable properties. This saves spring structures that are separate from the clamping elements 54. The clamping elements 54 are expediently in the form of leaf springs. By way of example, the spring elasticity is favoured by the curved section 73 which guarantees a relatively large stroke for the working movement 63 in conjunction with the build-up of a moderate spring force FF such that the clamping elements 54 securely hold the inserted wire conductors 8 and nevertheless can be moved into the open position 54b with little effort if a connected wire conductor 8 is to be removed again.

For the removal of inserted wire conductors 8 as required, the connection device 3 contains a release element 74 that is separate from the clamping elements 54 and which can be subjected to a manually generated release force FL in order to move all existing clamping elements 54 uniformly into the release position and lift them off each inserted wire conductor 8 for the purpose of releasing it so that it can be easily pulled out. It is particularly advantageous that the clamping elements 54 can in principle perform their working movement 63 independently of one another; however, all clamping elements 54 are collectively assigned a single and thus one and the same release element 74, through the actuation of which all clamping elements 54 can be moved into the open position 54b at the same time.

In the state not subjected to a release force FL, the release element 74 adopts an inactive position shown, for example, in FIGS. 1, 2, 4 and 5. In this inactive position of the release element 74, each clamping element 54 is able to adopt its basic position 54a. By way of example, this is achieved by virtue of the fact that in the inactive position of the release element 54, irrespective of the position of the clamping elements 54 and thus also in the basic position 54a of the clamping elements 54, there is a distance “A” between the release element 74 and each clamping element 54.

If a clamping element 54 adopts a clamping position 54c, its distance “A” to the inactive release element 74 is greater than in the basic position 54a.

When the release force FL is induced, the release element 74 can be driven from the inactive position to a release movement 75 indicated by an arrow, in the course of which it acts on all clamping elements 54 after bridging the distance “A” and entrains them, causing an opening movement 63a. Each clamping element 54 currently adopting a clamping position 54c is thereby moved from the clamping position 54c into the open position 54b, wherein the cross-section of the associated clamping region 53 is increased and the clamping of the inserted wire conductor 8 is released. The now released wire conductor 8 can consequently be removed from the associated connection channel 48 without resistance.

If, at the time of the opening movement 75, no wire conductor 8 is inserted into one of the plurality of connection structures 44, 45 and the associated clamping element 54 is therefore in the basic position 54a, it is nevertheless also moved along and into the open position 54b without affecting a wire conductor 8.

If needed, the open position 54b of the clamping elements 54 caused by actuating the release element 74 can also be used to insert a wire conductor 8 to be connected in accordance with insertion arrow 52 (FIG. 1). This makes the connection process easier, particularly with very thin wire conductors 8 or with wire conductors 8 of low rigidity designed as stranded conductors, because the clamping elements 54 then do not have to be deflected into the clamping position 54c solely by the insertion force of the wire conductors 8.

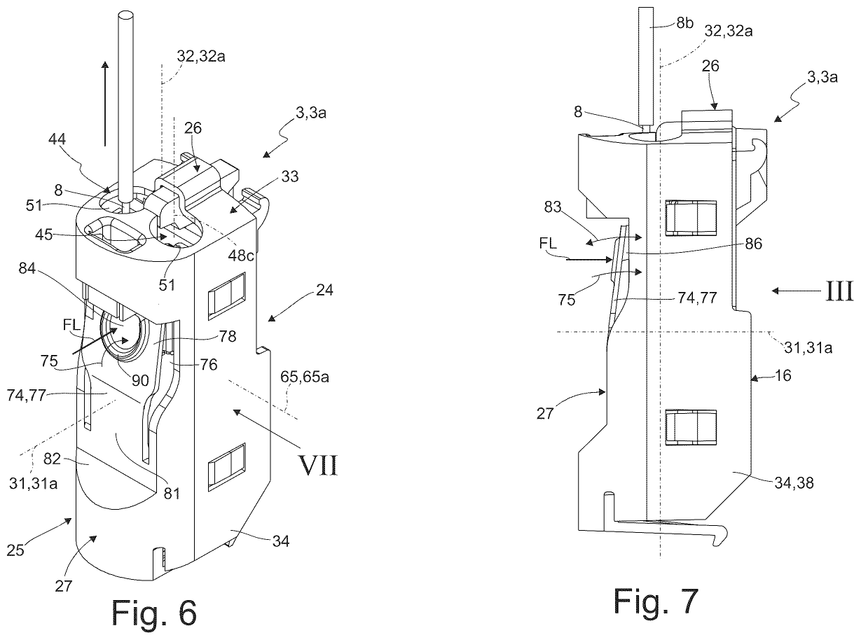

A position of the release element 74 in which it holds the clamping elements 54 in the open position 54b is referred to as the active position and can be seen FIGS. 6 to 10.

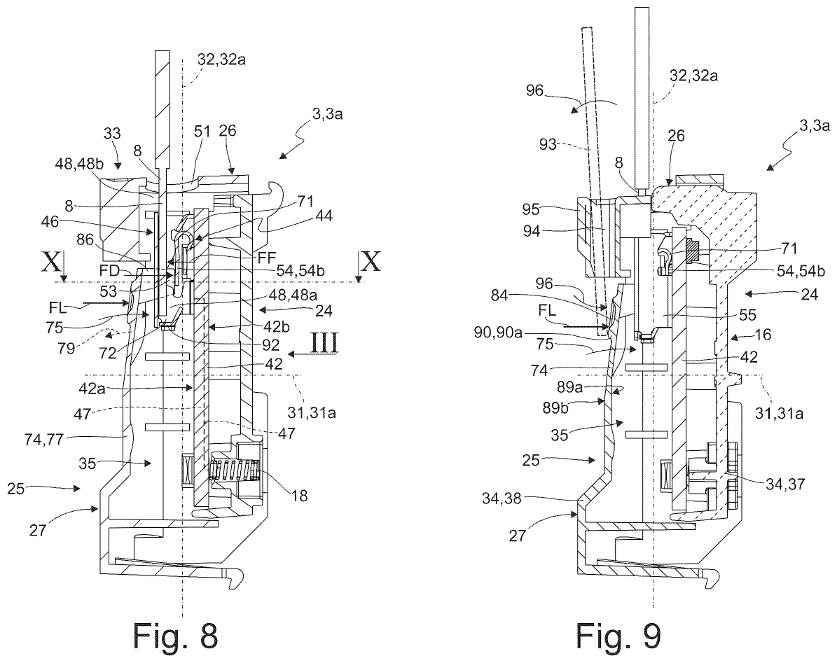

The release element 74 preferably has inherently resiliently bendable properties such that it automatically returns to the inactive position from the active position after the release force FL has been removed as part of a return movement 79 opposing the release movement 75 and indicated by dashed lines in FIG. 8. However, an embodiment is also possible in which the release element 74 is assigned a separate spring device for an automatic return movement 79 to the inactive position and/or in which the return movement 79 results from the closing movement 63b of the clamping elements 54, which push the release element 74 back into the inactive position.

The release element 74 is, for example, an integral part of the device housing 34. The device housing 34 preferably has a U-shaped recess 76 in the region of the front side 25, from which a tongue-like wall section 77 of the device housing 34 results, which forms the release element 74. The release element 74 is consequently tongue-like, wherein it has a root region 81 on one end, in which it is integrally connected to a residual part 82 of the device housing 34, with respect to which the connection structures 44, 45 are permanently fixed. The root region 81 is located in the region of the U-opening of the U-shaped recess 76. The release element 74 further has a free end section 78 spaced apart from the root region 81, which, during the release movement 75 and the opposing return movement 79 of the release element 74, is pivoted around in particular the root region 81. Overall, the release element 74 can accordingly be driven to a pivot movement 83 around the root region 81 by selectively imposing or removing the release force FL, which is the release movement 75 or the return movement 79 depending on the movement direction.

The tongue-shaped release element 74 is preferably integrally connected to the residual part 82 of the device housing 34 in the root region 81. The inherent spring elasticity results in particular from the resilience in the root region 81 and possibly also from a correspondingly small thickness and/or a suitable material selection.

For example, the device housing 34 and consequently also the release element 74 consists of a thermoplastic material, which provides a certain elastic deformability without the risk of breaking.

The release element 74 is expediently located in the region of the second outer surface 27 of the connection device 3, which is the case in the illustrated exemplary embodiment. The release element 74 is preferably equipped with an activation section 84 that can be used to introduce the release force FL and is also located in the region of the second outer surface 27. The activation section 84 preferably manifests itself in a visible local structure of the release element 74, which is, for example, a recessed structure surrounded by a bead 90, to which a finger of a hand can be conveniently and purposefully applied to introduce the release force FL.

The release element 74 is preferably designed such that a movement plane 85 in which the release movement 75 takes place is oriented parallel to the movement plane 68 of the clamping elements 54. Owing to the pivotability of the release element 74, the movement plane 85 is, for example, a pivot plane 85a. The movement plane 85 extends, for example, orthogonally to the transverse axis 65. A release force FL caused by the release movement 75 is exerted in the region of the front side 25 in the direction of the clamping units 46 located in the housing interior 35.

For the transmission of the release force FL to the moving clamping elements 54, the release element 74 preferably has a number of force induction protrusions 86 expediently corresponding to the number of clamping units 46, which protrusions protrude into the housing interior 35 in the longitudinal direction 31a. The force induction protrusions 86 are in particular designed like tabs.

Each force induction protrusion 86 extends up to one of the clamping elements 54 such that each force induction protrusion 86 is assigned one of the clamping elements 54. In the inactive position of the release element 74, the aforementioned distance “A” is expediently located between each force induction protrusion 86 and the clamping element 54 assigned thereto and adopting the basic position 54a.

For favourable force transmission of the release force FL to the clamping elements 54, it is advantageous if each clamping element 54 has a laterally projecting force absorption tab 87, which protrudes into a region upstream of the associated force induction protrusion 86. During the release movement 75, the force induction protrusions 86 can respectively exert a pressure force FD indicated in FIGS. 10 and 11 on the associated force absorption tab 87 in order to cause an opening movement 83a of the associated clamping element 54.

By way of example, the channel wall 57 of each connection channel 48 has a lateral wall recess 91 through which the force absorbing tab 87 of the associated clamping element 54 passes such that the force absorbing tag 87 projects outside beyond the channel wall 57. By way of example, the wall recesses are respectively located in a lateral wall section 66a of the base body 55 of the clamping unit 46 in question. The force induction protrusion 86 acting on the force absorption tab 87 of a clamping element 54 extends adjacent to the lateral wall section 66a next to the base body 55 of the associated clamping unit 46.

The force induction protrusions 86 are expediently arranged on the free end section 78 of the tongue-like release element 74 on its inner side 89a facing the connection structures 44, 45 and are integrally moulded in particular. They are arranged at a distance from each other in the transverse direction 65a that corresponds to the mutual distance between the force absorption tabs 87.

The channel end 72 of the connection channels 48 is expediently axially delimited by an end wall section 92 of the base body 55. The end wall section 92 expediently forms an insertion stop for the wire conductor 8 to be connected such that it can be inserted precisely with its connection end 8a into the connection channel 48 with an optimum insertion depth.

It may be the case that the directional control valve 1 is installed at a location in its use position such that the release element 74 is limited in its accessibility from the front side 25. If this is the case, the connection device 3 can have an integrated aid, which enables simple actuation from the upper side 33. The illustrated connection device 3 is equipped with such an aid, which is a tool insertion channel 94 enabling the insertion of a rod-shaped actuating tool 93 indicated by dashed lines.

The tool insertion channel 94 is preferably formed in the region of the front side 25 in a housing extension 95 projecting beyond the release element 74 in the longitudinal direction 31a, which on the one hand opens out adjacent to the wire insertion openings 51 on the first outer surface 26 and on the other hand is open in the region of the second outer surface 27 towards the release element 74 in a region which is located in front of an outside 89b of the release element 74 opposite the inside 89a. The tool insertion channel 94 preferably extends in the height direction 32a of the connection device 3, wherein its two openings are also oriented in this height direction 32a.

Tool-assisted manual actuation of the release element 74 is possible in accordance with the illustration in FIG. 9, for example, by inserting a hand-held actuating tool 93 formed for example by a screwdriver from the upper side 33 through the tool insertion channel 94 such that its tip comes to rest in the region of the outside 89a of the release element 74, whereupon the actuating tool 93 is pivoted according to arrows 96 such that the tip of the actuating tool 93 acts on the release element 74 with a release force FL. When pivoting according to arrows 96, the actuating tool 93 can be supported within the tool insertion channel 94 on the housing extension 95 such that a leverage effect is generated.

If the diameter of the actuating tool 93 corresponds approximately to the diameter of the tool insertion channel 94, the actuation of the release element 74 can also be caused purely by a linear pushing action of the actuating tool 93 even without pivoting the actuating tool 93, wherein it is expedient if the actuating tool 93 has an inclined surface on its tip and/or if the release element 74 has a force induction protrusion 90a on its outside 89b that can be acted upon in a targeted manner by the actuating tool 93. The force induction protrusion 90a can be formed, for example, by the aforementioned bead 90 of the activation section 84.

The connection device 3 described thus far enables a manual release force FL to be induced either through direct pressure with a finger of a hand or direct pressure by means of a hand-held actuating tool 93. In addition, however, the connection device 3 can be equipped with an actuating element 97 in addition to the release element 74, in accordance with the dotted line illustration in FIG. 2, which can be adjusted by a manually generated actuating force FB such that it acts on the release element 74 and produces the desired release force FL in this respect.

The actuating element 94 is in particular an actuating slide 97a, which is mounted on the device housing 34 so as to be displaceable orthogonally to the longitudinal axis 31 in accordance with double arrow 98. This configuration means that the force direction of the actuating force FB deviates from the force direction of the release force FL that can be produced and is in particular oriented perpendicular thereto. The associated force deflection can be advantageously combined with the effect of a greater release force FL compared to the actuating force FB for a force transmission. The release element 74 expediently has a force induction protrusion 97b, which is formed by the activation section 84, for example by the aforementioned bead 90, or by an independent section of the release element 74 and on which the actuating slide 97a can act with an inclined surface 99.

According to the separate sectional view surrounded by dashed lines in FIG. 1, the connection device 3 can optionally have a strain relief device 100, through which each connected wire conductor 8 is guided with a meandering, curved longitudinal section located outside the connection structures 44, 45. The aforementioned longitudinal section is expediently clamped in the strain relief device 100. The strain relief device 100 is preferably located on the front side 25 of the connection device 3, wherein it is integrated into the housing extension 95, for example. The strain relief device 100 has, by way of example, a number of strain relief slots 101 corresponding to the number of connection structures 44, 45, the slot opening of which points in the opposite direction to the wire insertion openings 51 such that the longitudinal section of the wire conductor 8 to be fixed can be inserted into a strain relief slot 101 from below.

1. An electromechanical connection device for a directional control valve, designed for the releasable connection of a plurality of wire conductors serving to supply power to the directional control valve, the electromechanical connection device comprising:
a plurality of connection structures, which respectively have a connection channel provided to insert a conductor wire to be connected, which has a clamping region, which is delimited laterally by a clamping element, which can be moved between a basic position and an open position defining a larger cross-section of the clamping region compared to the basic position,
wherein an opening movement of the clamping element occurring in the direction of the open position is accompanied by the build-up of a spring force provided by a spring structure and acting on the clamping element in a restoring manner in the direction of the basic position such that a wire conductor inserted into the associated clamping region can be electrically conductively clamped by the clamping element deflected from the basic position into a clamping position located between the basic position and the open position,
wherein the independently moveable clamping elements of all connection structures are collectively associated with a release element of the connection device, which, starting from an inactive position enabling each clamping element to assume its basic position, can be driven to a release movement acting on all clamping elements by introducing a manually generated release force, during which it causes an opening movement of all clamping elements, such that each clamped wire conductor can be released for removal from the associated connection channel.

2. The connection device according to claim 1, wherein the connection device is designed as a connection unit that can be handled as a single entity and has an electromechanical interface for in particular releasable attachment to a valve assembly of the directional control valve.

3. The connection device according to claim 1, wherein the clamping elements have inherently resiliently bendable properties and respectively themselves directly form the spring structure associated with them, wherein they are expediently designed like a leaf spring.

4. The connection device according to claim 1, wherein the clamping elements are designed to be tongue-like with a free end section and can be moved between the basic position and the open position as part of a pivot movement.

5. The connection device according to claim 1, wherein in the inactive position of the release element, irrespective of the position of the clamping elements, there is a distance between the release element and each clamping element and/or in that each clamping element is pre-tensioned into the basic position by the associated spring structure.

6. The connection device according to claim 1, wherein each connection structure has a clamping unit made of metal and fixed to a device housing of the connection device, in which the associated connection channel extends with at least one longitudinal section containing the clamping region and which has the associated clamping element as an integral component.

7. The connection device according to claim 6, wherein each clamping unit has a base body, which forms an electrically conductive channel wall of the associated connection channel, wherein the associated clamping element has a force absorption tab protruding outward beyond the channel wall, on which the release element can act to cause an opening movement of the clamping element.

8. The connection device according to claim 6, wherein each connection channel has an inner longitudinal section extending in the clamping unit and containing the clamping region and an outer longitudinal section adjacent thereto and formed in the device housing, wherein the outer longitudinal section ends outside on the device housing with a wire insertion opening enabling the insertion of a wire conductor to be connected.

9. The connection device according to claim 6, wherein the clamping units are mounted on a printed circuit board surrounded by the device housing and fixed in relation to the device housing and are electrically conductively connected via a conductor track structure to contact elements, at which an actuating voltage for the directional control valve, which produces the power supply, can be tapped.

10. The connection device according to claim 1, wherein the release element is designed to be tongue-like with a free end section, wherein the release movement is a pivot movement and wherein the release element is expediently an integrally integrated component of a device housing of the connection device.

11. The connection device according to claim 1, wherein the release element has inherently resiliently bendable properties in such a way that it can automatically return to the inactive position after an induced release force has been removed.

12. The connection device according to claim 1, wherein the connection channels extend in a height direction of the connection device with parallel alignment to one another and respectively end at a first outer surface of the connection device with a wire insertion opening, wherein the release element is arranged at least with an activation section that can be used for introducing the release force in the region of a second outer surface of the connection device orientated orthogonally to the first outer surface, wherein the release element expediently has a number of force induction protrusions corresponding to the number of clamping elements, which protrusions respectively act in a pressing manner on one of the existing clamping elements during the release movement which can be produced by acting on the release element to produce the opening movement.

13. The connection device according to claim 12, wherein on the first outer surface adjacent to the wire insertion openings, a tool insertion channel, which is open towards the release element in the region of the second outer surface and through which an actuating tool that can be used for inducing the release force can be inserted, opens out.

14. The connection device according to claim 1, wherein it has an actuating element interacting in a force-transmitting manner with the release element and expediently designed a an actuating slide, which can be adjusted by a manually produced actuating force in order to produce the release force by interaction with the release element, wherein the force direction of the actuating force expediently deviates from the force direction of the release force and is in particular oriented perpendicular thereto.

15. A directional control valve, having a valve member, an electrically actuated drive device for moving the valve member and an electromechanical connection device for the releasable connection of a plurality of wire conductors serving to supply power to the drive device, wherein the electromechanical connection device is designed according to claim 1.

16. The directional control valve according to claim 15, wherein the electrically actuated drive device is designed as a pilot control valve device, the electrical actuation of which can be used to control the application of a drive fluid to the valve member in order to move the valve member into different switching directions by controlled fluid application.

17. The directional control valve according to claim 15, wherein the electromechanical connection device is arranged directly on the electrically actuated drive device.

18. The directional control valve according to claim 15, wherein the valve member and the electrically actuated drive device belong to a valve assembly of the directional control valve, wherein the electromechanical connection device is designed as a connection unit that can be handled as a single entity and which has an electromechanical interface, via which it can be or is attached to a complementary electromechanical mating interface of the valve assembly in such a way that there is an electrically conductive connection between the connection structures of the electromechanical connection device and the electrically actuated drive device.

19. The directional control valve according to claim 15, wherein it has a longitudinal axis extending in a longitudinal direction and a vertical axis orthogonal thereto and extending in a height direction, wherein the electromechanical connection device is located in an axial end region of the directional control valve pointing in the longitudinal direction, wherein the connection channels of the connection structures open out at a first outer surface of the electromechanical connection device oriented in the height direction and the release element is arranged at least with an activation section that can be used for introducing the release force in the region of a second outer surface of the electromechanical connection device orientated in the longitudinal direction.
